(19) United States
(12) Patent Application Publication
(10) Pub. No.: US 2010/0209316 A1
(43) Pub. Date: Aug. 19, 2010

(54) APPARATUS FOR PRODUCING A CLEANING SOLUTION

(75) Inventors: Cornelius H. Groenewegen, Middletown, OH (US); Richard L. Sampson, Fair Oaks Ranch, TX (US); Allison H. Sampson, Fair Oaks Ranch, TX (US)

Correspondence Address: Diversey, Inc., 8310 16TH STREET, M/S 509, PO BOX 902, STURTEVANT, WI, 53177-0902, US

(73) Assignee: JOHNSONDIVERSEY, INC., Sturtevant, WI (US)

(21) Appl. No.: 12/293,776

(22) PCT Filed: Mar. 23, 2007
(86) PCT No.: PCT/US07/64805

§ 371 Date: Apr. 26, 2010

Related U.S. Application Data
(60) Provisional application No. 60/787,582, filed on Mar. 30, 2006.

(51) Int. Cl. B01J 47/00; B01D 15/04; B01J 8/02

(52) U.S. Cl. 422/211; 210/282; 210/93

(57) ABSTRACT

An apparatus for producing a cleaning solution. Specifically, the apparatus of some embodiments includes a reservoir for containing sodium chlorite. A disposable ion exchange cartridge is placed in fluid communication with the sodium chlorite reservoir via a conduit. The ion exchange cartridge is selectively disconnectable from fluid communication with the sodium chlorite reservoir or from the conduit. Generally, the ion exchange cartridge will be disconnected and replaced when the ion exchange materials in the cartridge are depleted or exhausted. A catalyst can also be placed in fluid communication with the sodium chlorite reservoir. The catalyst can be contained in disposable or selectively disconnectable cartridge that can be easily replaced when depleted. In another aspect of the invention, a color comparison chart is positioned adjacent a conduit to allow one to compare the color of the solution to the chart and determine the concentration of the solution.

### BACKGROUND

In some cleaning applications, one or more chemicals are reacted to form a cleaning solution when needed. During such cleaning applications, the cleaning process can be delayed or prolonged according to the amount of time needed to generate the cleaning product. Furthermore, depending upon the amount of cleaning solution needed, high demands can be placed on the reaction device or devices, such as ion exchange beds or catalyst containers, to satisfy peak demands. In order to expedite the production of cleaning solution, the reaction devices can tend to be quite large to allow a large amount of reactants or intermediate cleaning products to react in a timely manner. In one particular example, some conventional clean-in-place systems use a cleaning solution that is produced via chemical reaction just prior being used. However, because a clean-in-place system can require a large quantity of cleaning solution, the cleaning process can be significantly delayed waiting for the proper amount of cleaning solution to be produced.

Chlorine dioxide (ClO₂) can be used as the cleaning solution in some applications. Chlorine dioxide is known to have bleaching, disinfecting and sterilizing properties. For example, chlorine dioxide is a powerful viricide, bactericide, protocide, and algaecide. Accordingly, chlorine dioxide is used in a variety of large scale industrial applications including municipal water treatment as a bactericide, still water treatment, water hygiene taste and odor control, and zebra mussel infestation control, to name a few. It is used to bleach paper and flour, and it is also particularly useful where microbes and/or organic odorants are sought to be controlled on and around foodstuffs.

Unfortunately, chlorine dioxide is not stable for long periods of time. Specifically, at normal operating pressures and temperatures, chlorine dioxide is a gas and is extremely explosive. For example, chlorine dioxide can be explosive at pressures above about 0.1 atmosphere. Therefore, chlorine dioxide gas is not manufactured and shipped under pressure like other industrial gases. Rather, due to its inherent instability, chlorine dioxide must be produced in situ at the point of use.

Conventional methods of on-site manufacture prepare chlorine dioxide by oxidation of chlorites or reduction of chlorates, as needed. These conventional methods generally require expensive generation equipment and a high level of operator skill to avoid generating dangerously high concentrations. Due to these constraints, the use of chlorine dioxide has typically been limited to large commercial applications, such as pulp and paper bleaching, water treatment, and poultry processing, where the consumption of chlorine dioxide is sufficiently large that it can justify the capital and operating costs of expensive equipment and skilled operators for on-site manufacture.

U.S. patent application Ser. No. 09/919,918 teaches a process of generating chlorine dioxide that overcomes many of the disadvantages discussed above. The teachings of this patent application are hereby incorporated by reference. However, the teachings of this patent application, as currently incorporated in practice, generally requires an ion exchange vessel to be regenerated periodically. This regeneration generally involves the use introducing a strong acid into the vessel to exchange hydrogen ions for metal ions. While larger scale chlorine dioxide production can justify the expense of a system adapted to perform such regeneration, smaller scale applications cannot. This type of regeneration may limit the number of end users this process can reach.

### SUMMARY OF THE INVENTION

The present invention is directed to an apparatus for producing a chlorine dioxide or chlorous acid cleaning solution. The cleaning solution of some embodiments is produced by reacting and/or catalyzing one or more chemicals or reactants within a dispensing apparatus. For example, in one particular embodiment, sodium chlorite is fed through an ion exchanger to produce a substantially pure chlorous acid solution. If desired, the chlorous acid can also be fed through a catalyst to generate chlorine dioxide

Specifically, the apparatus of some embodiments includes a vessel, container, or reservoir for storing and/or containing sodium chlorite or other chemicals. A disposable ion exchange cartridge is placed in fluid communication with the sodium chlorite reservoir via a conduit. The ion exchange cartridge is selectively disconnectable from fluid communication with the sodium chlorite reservoir or from the conduit. Generally, the ion exchange cartridge will be disconnected and replaced when the ion exchange materials in the cartridge are depleted or exhausted. In some embodiments, a catalyst is also placed in fluid communication with the sodium chlorite reservoir. In one embodiment, the catalyst is placed downstream from the ion exchange cartridge. In other embodiments, it is integrated into the ion exchange cartridge. In either situation, the catalyst can he contained in disposable or selectively disconnectable cartridge that can be easily replaced when depleted.

In some embodiments the apparatus includes a reservoir for storing/containing sodium chlorite or other chemicals. A first disposable ion exchange cartridge is placed in fluid communication with the reservoir. A conduit can be provided to effectuate such fluid communication between the cartridge and the reservoir. The first ion exchange cartridge is selectively disconnectable from fluid communication with the reservoir. A second ion exchange cartridge can also be provided, wherein when the first ion exchange cartridge is depleted it can be disconnected and replaced with the second ion exchange cartridge.

In some embodiments of the invention, a visual indicator is provided to determine the concentration of chlorine dioxide produced. In some embodiments, the chlorine dioxide solution passed through a conduit having at least a portion that is translucent or transparent such that it can be seen through. A color comparison chart is positioned adjacent the conduit to allow one to compare the color of the solution to the chart and determine the concentration of the solution. With such visual indication, one can visually determine whether the ion exchange or catalyst cartridges need to he replaced.

These and other embodiments or aspects of the present invention, together with the organization and operation thereof, will become apparent from the following detailed description of the invention when taken in conjunction with the accompanying drawings.

### BRIEF DESCRIPTION OF THE DRAWINGS

FIG. 1 is a schematic representation of a cleaning solution generator embodying aspects of the present invention.

FIG. 2 is an alternative schematic representation of a cleaning solution generator embodying aspects of the present invention.

FIG. 3 is another alternative schematic representation of a cleaning solution generator embodying aspects of the present invention.

FIG. 4 is another alternative schematic representation of a cleaning solution generator embodying aspects of the present invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to he understood that the phraseology and terminology used herein is for the purpose of description and should not be regarded as limited. The use of “including,” “comprising” or “having” and variations thereof is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

### DESCRIPTION OF THE ILLUSTRATED EMBODIMENTS

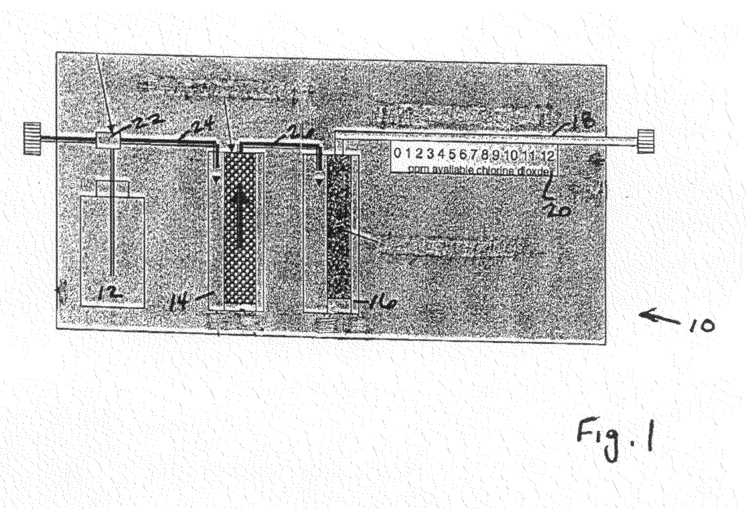

FIG. 1 illustrates one embodiment of a cleaning solution generating apparatus 10 embodying aspects of the present invention. Specifically, this apparatus 10 can produce a chlorine dioxide cleaning solution. However, this apparatus 10 can also be used to or adapted to produce other cleaning solutions. Thus, although the description provided below will primarily discuss the illustrated embodiment relative to the generation of a chlorine dioxide cleaning solution, the apparatus can be used to produce and dispense other cleaning solutions. For example, in one particular embodiment, this apparatus can be modified to yield chlorous acid as a cleaning solution.

As illustrated in FIG. 1, the apparatus 10 of the illustrated embodiment includes a reservoir, vessel, or other container 12 having sodium chlorite in fluid communication with an ion exchange cartridge 14 and a catalyst cartridge 16. As described in greater detail below, sodium chlorite is fed through the ion exchange bed to form chlorous acid. The chlorous acid then passes through the catalyst, which produces chlorine dioxide. As shown in the illustration, the chlorine dioxide can then be discharged through a substantially clear line 18 (or portion thereof), wherein the line is positioned adjacent a color comparison chart 20 to provide visual indication of the concentration of chlorine dioxide in the solution.

As mentioned above, sodium chlorite is stored in a vessel, reservoir, or other container 12. Although sodium chlorite is specifically used in this embodiment, other reactants can be stored as a precursor chemical. For example, in other configuration of the device shown in FIG. 1, sodium chlorate can be used to generate chlorine dioxide.

As shown in this embodiment, sodium chlorite can be selectively drawn out of the container via a venturi, proportioning pump, and the like 22. Such devices will draw an appropriate amount of sodium chlorite from the container relative to a flow rate of water or other solution passing through the device.

Once the sodium chlorite is drawn from the container 14, the sodium chlorite is fed in a dilute form via a conduit 24 into the ion exchange cartridge 14. In this embodiment, the ion exchange cartridge 14 is selectively disconnectable from the cleaning solution generating apparatus 10 or conduit 24. Although it is not specifically illustrated, the ion exchange cartridge can be provided with a quick connect type fitting to connect to the cleaning solution generating apparatus 10 or conduit 24. For example, one or more clamps can be utilized. Additionally, bayonet type connections utilizing male-female engagement of elements can be utilized. In some embodiments, a threaded engagement can also be used. Various other connections known in the art can be used to connect the cartridge 14 to the cleaning solution generating apparatus 10 or conduit 24 so long as the connection can be severed with relative ease. For example, a welded or soldiered connection generally can not be severed with relative ease.

The cartridge 14 is designed to selectively disconnect from the cleaning solution generating apparatus 10 or conduit 24 so that it can be replaced. Specifically, most ion exchange cartridges or vessels 14 eventually lose their effectiveness after a specific amount of ion exchange. In other words, over time, the ion exchanging capabilities of the ion exchanger become substantially diminished or exhausted. In conventional systems, the ion exchange material would generally be recharged or regenerated. U.S. Pat. No. 5,108,616 shows one particular way of regenerating the ion exchanger. Unfortunately, as discussed above, some cannot afford the infrastructure needed to perform such processes. Accordingly, the ion exchanger of the present invention has been design to be selectively removed so that a different ion exchanger that is fully charged can be coupled to the cleaning solution generating apparatus 10. Specifically, the example discussed herein, an exhausted ion exchange cartridge can be replaced with a pre-acidified ion exchange cartridge.

In the illustrated embodiment, the ion exchange cartridge 14 includes a resin bed where hydrogen (H⁺) is exchanged for sodium (Na⁺) to convert the sodium chlorite to chlorous acid or a relatively stable mixture containing chlorous acid. Generally, this will result in substantially pure chlorous acid.

As shown in the figures, a conduit 26 extends from the ion exchange cartridge 14 to the catalyst cartridge 16. Accordingly, the chlorous acid is delivered to the catalyst cartridge 16 via this conduit 26. Within the catalyst cartridge 16, the chlorous acid then contacts a catalyst, which causes chlorine dioxide to be produced. As described in U.S. patent application Ser. No. 09/919,918, this catalyst can be a variety of materials. In one particular embodiment, the catalyst is a platinum material.

Like the ion exchange cartridge 14, the catalyst cartridge 16 is designed to selectively disconnect from the cleaning solution generating apparatus 10 to allow the cartridge 16 to be easily replaced. This cartridge 16 can be coupled to the cleaning solution generating apparatus 10 many different ways, as described in more detail above.

Finally, in some embodiments, such as the one illustrated, a discharge conduit 18 extends from the catalyst cartridge 16. One or more portions of the conduit 18 can be made of substantially clear, transparent or translucent materials to allow the chlorine dioxide solution to be viewed. Alternatively, another conduit can be diverted from the conduit to allow the solution to be viewed. As illustrated, a color comparison chart 20 can be positioned adjacent the conduit 18. As such, the color of the chlorine dioxide solution can be compared to the color comparison chart 20 to determine the concentration of chlorine dioxide in the solution. The background in the area where the solution is viewed can be made white or some other color so that the color viewed is not distorted or changed by the background.

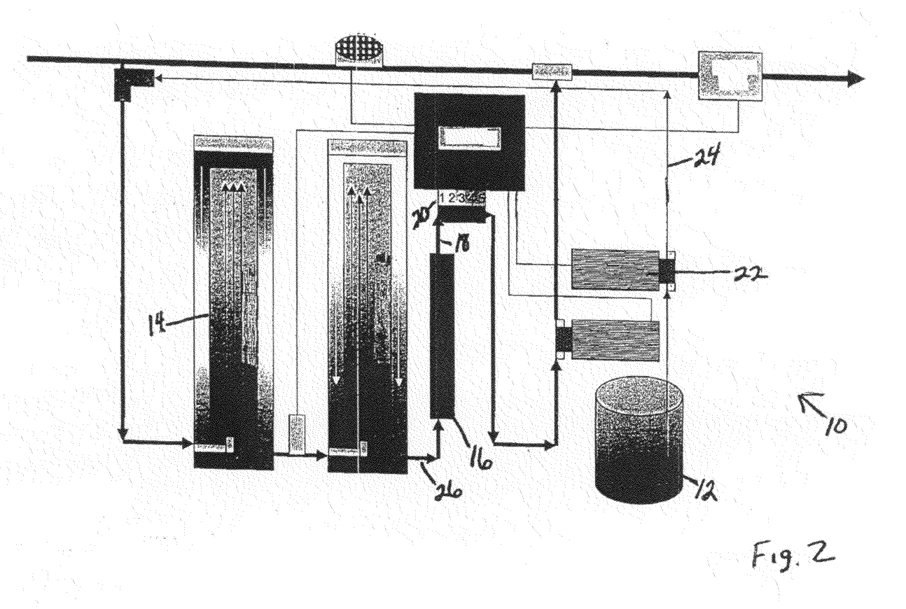

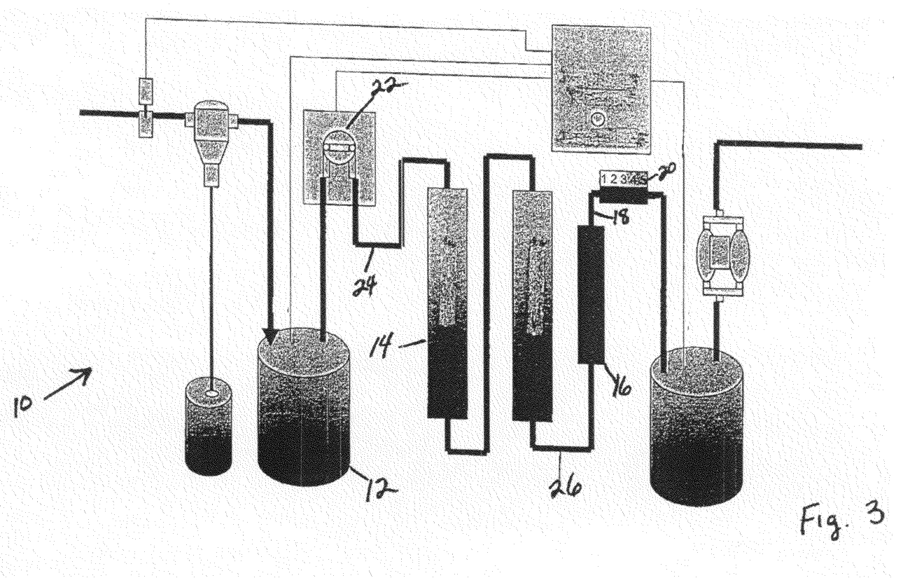

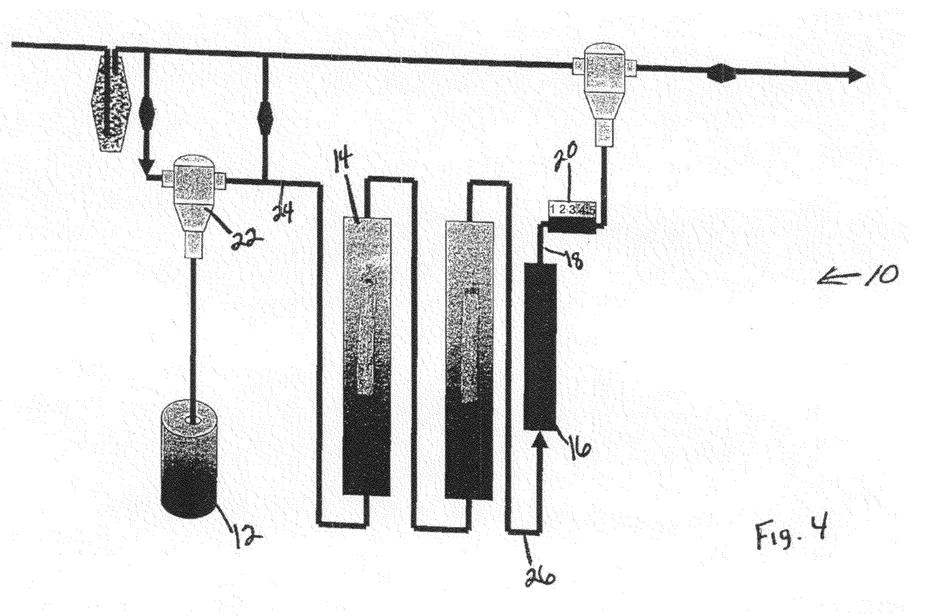

The embodiment described above included several features in combination with each other that generally do not need to be used together in practice. For example, some embodiments do not need to include a color comparison chart 20 in combination with disposable cartridges 14, 16. Rather, these concepts can be used independent of each other. Furthermore, in some embodiments, both an ion exchange cartridge 14 and a catalyst cartridge 16 do not need to be used together. Rather, the ion exchanger can be utilized as a cartridge 14 while the catalyst is presented in a more conventional form (i.e., not in a cartridge). Additionally, in some embodiments, the ion exchange cartridge 14 and the catalyst cartridge 16 can be combined into a single cartridge. In such an embodiment, the ion exchange materials and the catalyst materials can be placed in the same vessel, or alternatively, they can be in separate vessels (i.e., a wall or other structure separates the materials) that form one disconnectable cartridge. Some of these various embodiments are illustrated in FIGS. 2-4, with various elements identified similar to those in FIG. 1.

Various alternatives to the certain features and elements of the present invention are described with reference to specific embodiments of the present invention. With the exception of features, elements, and manners of operation that are mutually exclusive of or are inconsistent with each embodiment described above, it should be noted that the alternative features, elements, and manners of operation described with reference to one particular embodiment are applicable to the other embodiments.

Various features of the invention are set forth in the following claims.

What is claimed is:

1. An apparatus for producing a cleaning solution comprising:
a) a reservoir for containing a chemical;
b) a disposable ion exchange cartridge in fluid communication with the reservoir;
said cartridge being selectively disconnectable from fluid communication with the reservoir.

2. The apparatus of claim 1 further comprising a catalyst in fluid communication with the reservoir.

3. The apparatus of claim 2 wherein the catalyst is contained in the cartridge.

4. The apparatus of claim 1 further comprising a conduit connected to the cartridge whereby cleaning solution exits the cartridge via the conduit.

5. The apparatus of claim 4 wherein the conduit includes at least a portion that is clear, transparent or translucent.

6. The apparatus of claim 5 further comprising a comparison chart positioned adjacent the conduit whereby when a cleaning solution is passed through the conduit the color of said solution can be compared to a color on the chart to determine concentration of the solution.

7. The apparatus of claim 1 wherein the chemical is sodium chlorite.

8. An apparatus for producing a cleaning solution comprising:
a) a reservoir for containing a chemical;
b) a first ion exchange cartridge in fluid communication with the reservoir, said cartridge being selectively disconnectable from fluid communication with the reservoir;
c) a second ion exchange cartridge, wherein when the first ion exchange cartridge is depleted the first ion exchange cartridge can be disconnected and replaced with the second ion exchange cartridge.

9. The apparatus of claim 8 wherein the chemical is sodium chlorite.
